(19) United States
(12) Patent Application Publication
(10) Pub. No.: US 2015/0196886 A1
(43) Pub. Date: Jul. 16, 2015

(54) TUBE HEAT EXCHANGE ASSEMBLY AND APPARATUS, IN PARTICULAR A REACTOR FOR THE PRODUCTION OF MELAMINE, COMPRISING SUCH A HEAT EXCHANGE ASSEMBLY

(71) Applicant: EUROTECNICA MELAMINE, LUXEMBURG, ZWEIGNIEDERLASSUNG IN ITTIGEN, Ittigen (CH)

(72) Inventor: Roberto Santucci, Gorla Maggiore, Varese (IT)

(21) Appl. No.: 14/592,103

(22) Filed: Jan. 8, 2015

(30) Foreign Application Priority Data
Jan. 10, 2014 (IT) MI2014A000028

(51) Int. Cl. B01J 19/00

(52) U.S. Cl. CPC B01J 19/0013

(57) ABSTRACT

The present invention refers to a tube heat exchange assembly comprising
a tube plate (101) that has a first face which, in use conditions, is facing inside a heat exchange chamber (140), and a second face opposite to said first face and which, in use conditions, is facing outside said heat exchange chamber (140), at least one through hole (103) which passes through the thickness of said tube plate (101) and at least one heat exchange tube (100) which passes through said through hole (103) and is operatively associated with a supply circuit of a heat exchange fluid, wherein said tube heat exchange assembly further comprises at least one sleeve (200) opened at the opposite ends and fixed to said tube plate (101) and to said tube (100), said sleeve (200) being housed in said hole (103) and fitted on said tube (100) at a section of the latter wherein it crosses the thickness of the tube plate (101), wherein furthermore said sleeve (200) protrudes beyond said first face of the tube plate (101), so that a first open end of the same ends inside said heat exchange chamber (140); a further object of the invention is an apparatus comprising such a heat exchange assembly.

The present invention refers to a tube heat exchange assembly and an apparatus comprising such a heat exchange assembly.

The apparatus consists, in particular, of a chemical reactor and, more particularly, of a chemical reactor for the production of melamine.

Melamine is known to be produced by pyrolysis of urea according to the overall reaction (1):

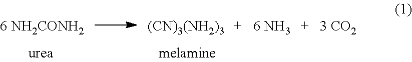

a reaction which, as known, is highly endothermic.

The processes for the transformation of urea into melamine are differentiated into two groups: processes that perform the pyrolysis of urea at high pressure and processes that perform the pyrolysis of urea at low pressure.

Both these processes are typically carried out in reactors which are fed with a stream of urea in the molten state. Preferably, the reactor is also fed with a stream of ammonia.

In the high pressure processes, the reaction chamber is kept at a pressure higher than 60 barᵣₑₗ and is equipped with heating means which keep the reaction system at a temperature of about 360° C.-450° C.

In the known reactors, both in the high and low pressure processes, the heating means consist of a tube bundle crossed by a heat exchange fluid made up, for example, of molten salts, which are typically made up of a mixture of nitrates and nitrites of sodium and potassium.

In a typical high pressure process, the tube bundle comprises a tube plate which is anchored to the shell of the reactor so as to delimit with it the reaction chamber 140.

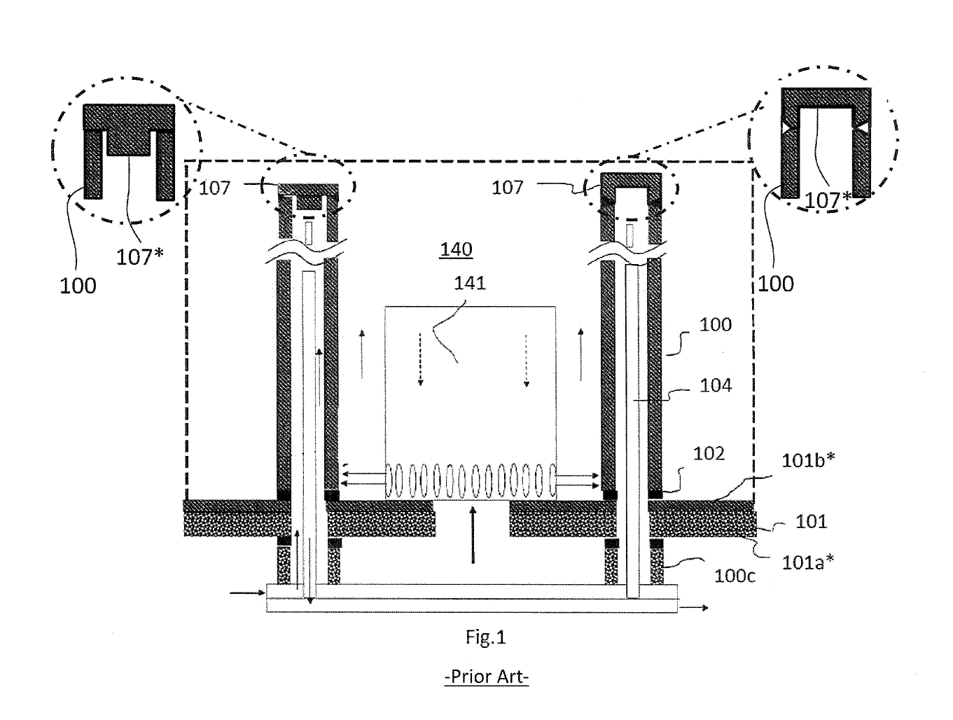

As shown in the accompanying FIGS. 1 and 3, each tube 100 of the bundle, or a branch of it if it is shaped as a U or a serpentine, is individually fixed to the tube plate 101 by means of a weld 102 which can be a butt weld (FIG. 1) or on the transition area between the face of the tube plate facing the inside of the reaction chamber 140 and the outer lateral surface of each tube (FIG. 3).

Each tube 100 is closed in its end inside the reaction chamber by means of a special plug 107* which can be of a simple shape, shaped as an inverted cup, T-shaped (as shown in FIG. 1) or of any other shape suitable for the purpose.

In this regard, it is noted that different types of plugs 107*, among those briefly described above, are shown in the accompanying figures.

Two different types of plugs 107*, in particular, are shown only for illustrative purposes in the enlargements of FIG. 1.

Inside each tube 100, coaxial to it and loose, a duct 104 open at the opposite ends is inserted; the inner channel in each duct 104 and the interspace defined between it and the respective tube 100 thus define the flow paths (outward and inward) of the molten salts. As schematically represented in FIGS. 1 and 3, the second section 100b of the tubes 100 and the end of the respective duct 104 that protrudes from it are respectively joined to a second tube plate 110 and a third tube plate 111, which delimit channels of distribution and collection of the molten salts.

The junction is made by means of welding, expanding or any other appropriate system.

In particular, in the case shown in FIG. 1, wherein the tube 100 is butt-welded to the tube plate 101 on the inner side of the reaction chamber, the junction between the tube plate 101 from the outer side of the reaction chamber to the tube plate 110, which delimits the channel of distribution and collection of the molten salts, is made by means of a tube section 100c joined to the two plates by welding, expanding or any other appropriate system.

The various elements in contact with the process fluid in the reaction chamber 140 (tube plate and tubes) are made of materials with a high resistance to corrosion, having to contact a reaction system with severe operating conditions.

Typically, such elements are made of steels or special alloys such as, for example, nickel-molybdenum-chromium Hastelloy® C276, C22, A 59 alloy, Inconel 625.

In particular, the tube plate 101 may be made of a single material, resistant to the conditions of the reaction chamber, or by coating the less noble material 101a* with the material required by the operating conditions 101b*.

The coating can be made by filling of material or with any other method of coating according to the known art. Moreover, the various elements are mutually fixed by welding.

As known, the welding is carried out by localised melting of the strips to be welded with or without filler metal having the same nature as the base metal of the two elements to be joined; such a fusion creates a permanent connection of the two elements with a substantial material continuity.

Typically, the tubes 100 are distributed along concentric circumferences around the duct 141 of recirculation of the reacting mass which is generally present at the centre of the reaction chamber 140. Typically, but not necessarily, the reaction mass circulates in a descending direction in the central recirculation duct and, joining the mass of molten urea and, preferably, of supply ammonia, comes out, for example by means of special openings, in the area closest to the tube plate coming in contact with the tubes 100 of the tube bundle in the area of union to the tube plate with a direction transverse to the pipes 100 to go back up into the tube-between-tube spaces.

Moreover, even in the case of reverse circulation, the section of the tubes 100 close to the tube plate 101 is still hit by the fluid recirculating in the direction transverse to the tubes themselves.

As known, the impact of a fluid on a surface causes an erosion of the surface itself and the erosion is greater as the impact angle gets close to 90°.

From checks performed on tube bundles constructed according to the state of the art, the tubes 100 of the tube bundle are subject to a phenomenon of erosion in the area of impact with the recirculating fluid.

Analysing more closely the phenomenon described above, it was noted that the tubes of the tube bundle distributed along the innermost circumference, these being closest to the exit point of the recirculating mass from the central duct 141, are subject to greater erosion compared to those distributed along the outermost circumferences.

During said check, it was also pointed out that the welds presented signs of fatigue probably due to vibrations that may be present in certain regimes of turbulent motion.

It should also be noted that said welds are performed between surfaces of different thickness, in particular the large difference in thickness, and therefore mass, between the tube and tube plate results in a considerable difference in heating, melting and cooling times during the execution of the weld between the two surfaces concerned, which may generate internal stresses in the material itself (for example to weld the outer wall of the tube with the tube plate, the amount of heat to melt the surface of the tube plate is such that the fusion on the wall of the tube continues up to the inner surface of the same).

The welding area is therefore subject to mechanical stresses and, in contact with an aggressive mixture (for example molten salts with the presence of degradation products such as NaOH), can be subject to intergranular corrosion.

To overcome the drawback of overheating caused in the tube/tube plate butt welding in the presence of different thicknesses, and thus masses, one knows to form a shank 108, of the same thickness as the tube, by means of mechanical processing of the surface 101b* of the tube plate (see FIG. 3).

In this case, it was found, however, that, in addition to the fact of having the fusion material directly in contact with the heating fluid (for ex. molten salts), strong stresses remain present in the shank itself due to the mechanical processing necessary for its realisation with a predisposition to be subject to intergranular corrosion.

It should also be pointed out that after joining the various elements (plate and heat exchange tubes) by means of welding, it is practically impossible to subject the entire bundle to heat treatments aiming to eliminate internal stresses that are generated either by mechanical processing or by effect of the localised heating and the subsequent cooling and shrinking of the material, such as for example heat treatments of annealing, resolubilisation or normalisation.

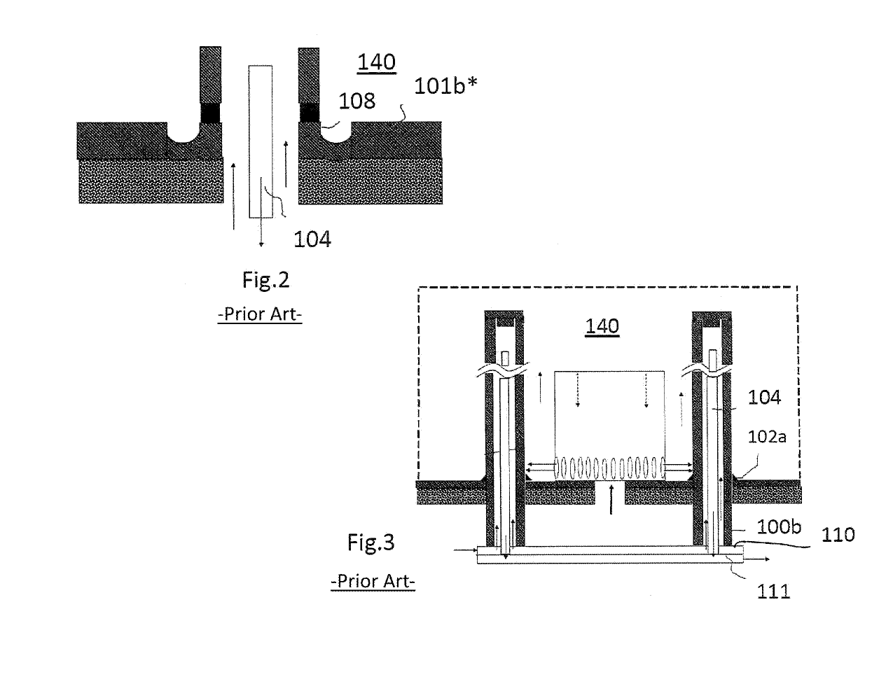

It is therefore obvious that, in case of leakage through the plate/tube weld 102 as per FIG. 1, either by direct leakage through the weld or by intergranular corrosion of the pipe portion and/or the shank in the case of the weld as per FIG. 2, or by intergranular corrosion of the side portion of the tube concerned by the weld 102a, FIG. 3, the reaction chamber and the heating circuit being at different pressures, there is a leakage that brings the two different fluids into contact.

In particular, if the reaction chamber operates at a pressure higher than the pressure of the heating circuit, the process fluid, for example melamine and ammonia, enters into the heating circuit itself with overpressure of the entire heating circuit and a danger of burst.

The object of the present invention is to solve the above-mentioned drawbacks of the known art (for ex. erosion and welds between different thicknesses) by means of the implementation of a tube heat exchange assembly and an apparatus comprising such an assembly, in particular a reactor for the production of melamine, of improved characteristics of structural strength and which allow eliminating the phenomena of erosion of the portion of the tubes near the tube plate.

A further object of the present invention is to provide a tube heat exchange assembly and an apparatus, in particular a reactor for the production of melamine comprising such an assembly, which can reduce the risks of formation of cracks and fissures.

In particular, the object of the invention is to reduce the risks of formation of cracks and fissures in the heat exchange tubes, with the resulting reduction of the risk of contact and possible reaction/explosion between the heat exchange fluid circulating inside the tubes and the material inside the reaction chamber, whether it be a fluid to be heated/cooled or a reaction system, that externally strokes the tubes themselves. These and other objects are achieved by a tube heat exchange assembly and an apparatus, in particular a reactor for the production of melamine according to the appended independent claims.

The general idea underlying the invention is to arrange for each tube at least one sleeve open at the opposite ends and fixed to said tube plate and to said tube, wherein the sleeve is housed in the hole and fitted on the tube at a section wherein the latter crosses the thickness of the tube plate.

The sleeve is preferably connected to the tube plate by means of a weld housed in the heat exchange chamber. This advantageously allows achieving a sealing between the tube plate and the sleeve capable of preventing seepage of the fluid contained in the reaction chamber into the border area defined between the external wall of the sleeve and the wall of the through hole of the plate. If such seepage takes place, the reactant contained in the reaction chamber could reach the portion of the plate which is not resistant to the conditions of the reaction chamber since it is usually made of less noble material.

In detail, in case of reactors for the production of melamine, such seepage would lead to corrosion and therefore to a rush impairment of the tube plate.

Preferably, only one connection point between the tube and the sleeve and/or between the sleeve and the tube plate is provided for.

Advantageously, a so obtained connection can stand different thermal expansions that the constrained elements can possibly experience, for example in reactors for the production of melamine.

In such reactors, during the initial heating phase, namely starting from an empty reactor, very different heating speeds of the elements can be achieved, thereby causing different expansion speeds of the elements.

Such differences are due to the fact that, starting from an empty reactor, namely with each element at a temperature much lower than the reaction temperature, the heat exchange tube is crossed by the molten salts which are at a very high temperature. This causes a quick warming-up of the tube.

Contrary to that, the sleeve is warmed-up by the tube and on its turn warms-up the tube plate, so that it reaches the reaction temperature much more slowly.

Accordingly, the tube plate shows a further delay in reaching the reaction temperature since it is warmed-up by the sleeve.

Thus, it has revealed to be very advantageous to provide for only one connection point between couples of elements (tube-sleeve and/or sleeve-plate) so that a relative expansion between the connected elements is not hindered.

Furthermore, the sleeve protrudes beyond the first face of the tube plate, so that a first open end of the same ends inside said heat exchange chamber.

A further object of the invention, in addition to the above-mentioned assembly, is also an apparatus that comprises such an assembly.

In this way, as will be seen in more detail later, the problems related to the known solutions are overcome.

Further advantageous features are the object of the appended claims, which are considered an integral part of this text.

The invention will seem more obvious from the accompanying figures, wherein:

FIGS. 1-3 depict the solutions belonging to the state of the art, discussed above;

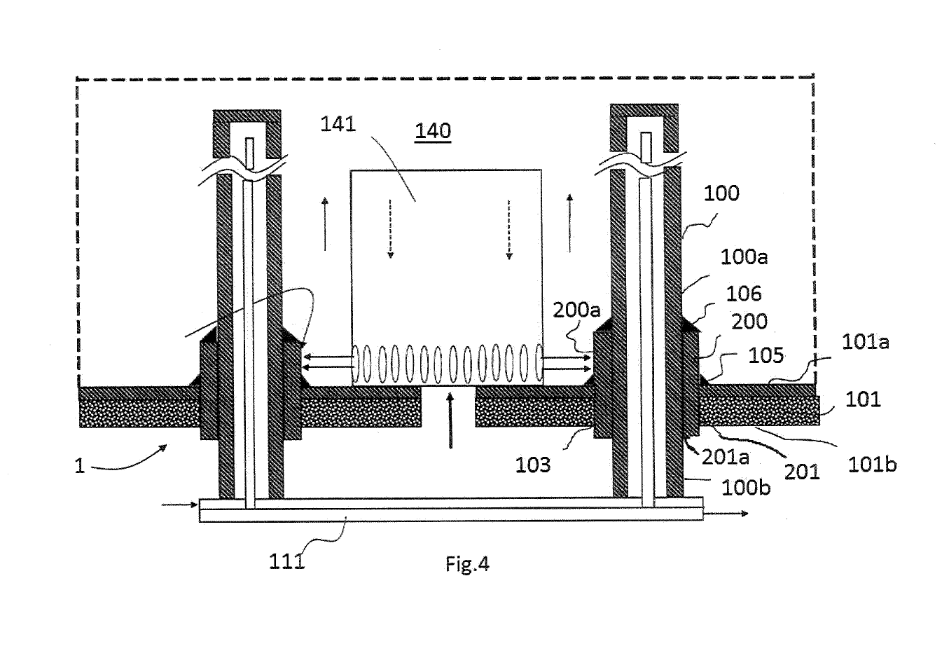

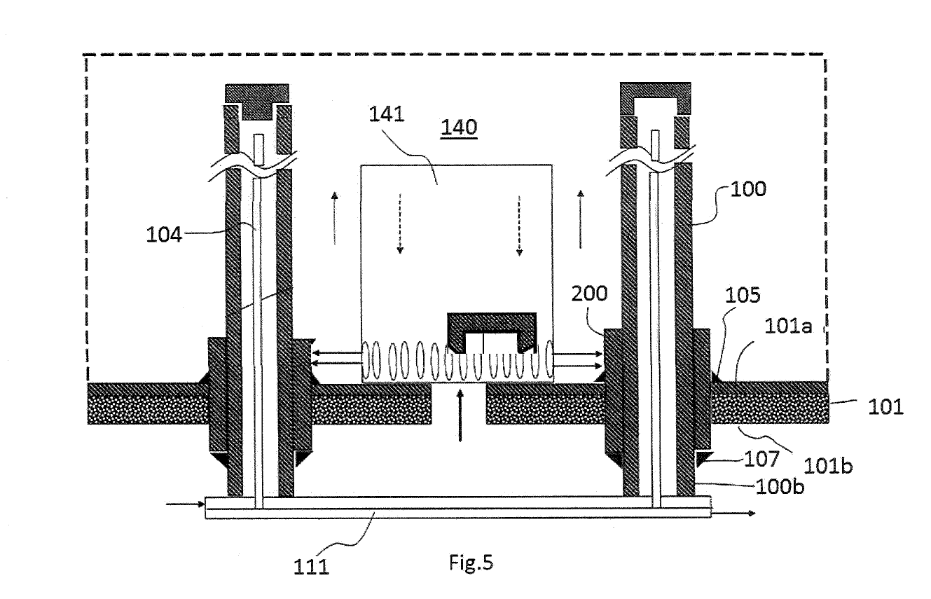

FIG. 4 depicts a schematic section view of a reactor provided with the heat exchange assembly according to the invention in a first embodiment;

FIG. 5 depicts a schematic section view of a reactor provided with the heat exchange assembly according to the invention in second embodiment.

According to the invention and with reference to FIGS. 4 and 5, the salient features common to the two embodiments (1 and 1A) are first described.

According to the invention, the tube heat exchange assembly 1 and 1A comprises a tube plate (101) that has a first face 101a which, in use conditions, is facing inside a heat exchange chamber 140, and a second face 101b opposite to said first face 101a and which, in use conditions, is facing outside said heat exchange chamber (140).

In the tube plate 101 at least one through hole 103 is made which passes through the thickness of said tube plate 101 and leads to the opposite faces 101a and 101b.

Advantageously, for the objects highlighted above, the hole 103 is housed in a sleeve 200 open at the opposite ends and fixed to the tube plate 101.

Internally to the sleeve 200, preferably in a substantially coaxial manner, a heat exchange tube 100 is housed which, therefore, passes through the through hole 103 and extends into the chamber 140.

The tube 100 is operatively associated, in a per se known manner, with a supply circuit of a heat exchange fluid.

The sleeve 200 is thus fitted on the tube 100 at a section wherein the latter crosses the thickness of the tube plate 101.

The sleeve 200 then protrudes beyond the first face 101a of the tube plate 101, so that a first open end of the sleeve 200 ends inside the heat exchange chamber 140.

This advantageously allows avoiding the phenomena of erosion in the area of impact with the fluid recirculating inside the chamber 140, because the portion of the sleeve 200 which projects beyond the face 101a protects the tube 100.

Advantageously, in this sense, the sleeves 200 extend from the first face 101a by a length equal to or greater than the height of the radial openings of the recirculation duct.

Note that, advantageously, the sleeve 200 is fixed alternately or in combination to the tube plate 101 or to the tube 100 by welding.

In both embodiments 1 and 1a, the fixing of the sleeve 200 either to the plate 101 or the tube 100 is made by welding, but, more generally, at least one of these fixings may differ, being made, for example, by means of flanged joints or similar.

It is hardly necessary to note that, in both embodiments 1 and 1a, welds between the tube 100 and the tube plate 101 are completely absent, because the sleeve 200 is completely interposed between the two.

This, in view of the objects outlined above, allows avoiding the problems between welds of materials with a different thickness, thus avoiding the problems associated with them, which will not be discussed for the sake of brevity.

In particular, this arrangement is particularly advantageous when the sleeve 200 has a thickness lower than that of the tube plate 101 and, preferably, has a thickness similar to or lower than that of the tube wall 100.

With regard to the second open end of the sleeve 200, namely the one facing the outside of the chamber 140, different situations may occur in general.

In some embodiments, the second open end ends flush with the second face 101b of the plate 101, while in other preferred solutions, the sleeve 200 protrudes beyond the second face 101b of the tube plate 101, so that the second open end ends outside said heat exchange chamber 140, protruding for a certain distance beyond the face 101b.

Referring now comparatively to embodiments 1 and 1a, these are associated by the fact that the sleeve 200 is welded to the tube plate 101 by means of a first weld 105 made between a body portion of the sleeve 200 and the edge of the hole 103, from the side of the first face 101a of the tube plate 101: in this way the first weld is housed in the heat exchange chamber 140.

These two embodiments differ instead for the position of the second weld, namely the one that fixes the sleeve 200 and the tube 100 together: in the first embodiment 1, the second weld is made between the first open end of the sleeve 200 and a contiguous portion of the outer lateral surface of said tube 100, so that the second weld is housed in the heat exchange chamber 140; in the second embodiment 1a, instead, the second weld is made between the second open end of the sleeve 200 and a contiguous portion of the outer lateral surface of said tube 100, so that the second weld is housed outside the heat exchange chamber 140.

Both assembly 1 and assembly 1a of the invention are then comprised in a heat exchange apparatus also comprising a shell wall and wherein the tube plate 101 is disposed to delimit, in cooperation with the shell, the heat exchange chamber 140; the first face 101a of the tube plate 101 is the one facing inside the heat exchange chamber 140.

More in detail, the apparatus comprises at least one inlet mouth for urea in the molten state, under pressure and preferably at a temperature of 135-145° C., inside said heat exchange chamber 140, so that the latter constitutes in practice the reaction chamber for the pyrolysis of the urea with formation of melamine. Referring now to FIGS. 4 and 5 for embodiments 1 and 1a, note that—for convenience—the same parts of the assembly and of the reactor of FIGS. 1-3, which were discussed above and which will not be discussed any further, have been indicated with the same reference numbers.

To understand in detail the present invention, a specific reference is now made to the assembly of the tubes 100 to the tube plate 101: according to the invention, sleeves 200, preferably made of the same material as the tubes, are provided which are fitted on the tubes 100 at least at the tube plate 101.

The sleeves 200 have a thickness similar to, or preferably equal to, or even more preferably lower than, the thickness of the tubes 100 themselves.

In more detail, the tube plate 101 is crossed in thickness by a plurality of holes 103 inside each of which a respective sleeve 200 is inserted open at the opposite ends, one of which extends beyond the face 101a of the tube plate 101 facing inside the reaction chamber 140 and the other, in this example, ends flush with the opposite face 101b of the tube plate 101 (FIG. 4) or, as in the second embodiment 1a (FIG. 5), protrudes from it.

Inside each sleeve 200 a respective tube 100 is inserted which extends beyond the opposite ends of the sleeve 200 respectively in a first section 100a inside the reaction chamber 140 and in a second section 100b external to it.

In more detail, each sleeve 200 is fixed to the tube plate 101 by means of a first weld 105 made at the transition zone between the face 101a of the tube plate facing inside the reaction chamber 140 and the outer lateral surface of each sleeve 200, thereby delimiting the interspace 201 between the section of the sleeve which ends outside the reaction chamber and the tube plate.

In this way, advantageously, in case of leakage from the welding area 105, there would be leakage of process fluid through the interspace 201 which communicates with the exterior of the tube bundle in the atmospheric area and therefore without any danger of contact between the process fluid and the heating fluid.

The tube 100, instead, is fixed to the respective sleeve 200 by means of a second weld 106 made at the end of the sleeve 200 which extends inside the reaction chamber 140 and a corresponding portion of the outer lateral surface of the first section 100a of the tube 100 that extends outside the sleeve 200 and inside the reaction chamber 140; here it is also obvious that, in case of leakage from the welding area 106, there would be leakage of process fluid through the interspace 201a which communicates with the exterior of the tube bundle in the atmospheric area and therefore without any danger of contact between the process fluid and the heating fluid.

The sleeves 200 that support the tubes 100 have a portion 200a which extends inside the reaction chamber of such a length as to protect the surface of the tubes 100 from phenomena of erosion caused by the impact of the fluid recirculating inside the reaction chamber.

The precise length of such a portion 200a may be easily chosen by one skilled in the art in light of the present teachings and depending on the particular geometry of the reactor, without thereby departing from the scope of protection of the invention.

In some embodiments, the sleeves that support the tubes 100 located in the area closest to the recirculation duct have a length greater than those that support the outermost tubes 100, which may instead be shorter so as to not hinder the heat exchange.

In other embodiments, instead, the sleeves 200 have all the same length.

A variation is shown in FIG. 5: also in this case, the same parts described above and which will not be further discussed are indicated by the same reference numbers.

In this variation, the second weld (indicated by reference 107) of union between the tube 100 and the sleeve 200 is carried out between the end of the sleeve 200 which protrudes from the face 101b of the tube plate 101, external to the reaction chamber and therefore in the atmospheric area, and the corresponding portion of the section 100b of the tube 100 which extends outside the sleeve.

The heating/cooling fluid circulation circuit is no longer described here, since it is not subject to changes compared to the above state of the art.

Finally, as regards the plugs, these may be of the known types described above, the use of a particular type of plug being considered to have no influence on what has been described so far.

In this regard, it is only noted that such plugs are usually coupled to the tubes 100 or by welding (such as the cup-shaped plugs), or by means of a forced insertion followed by welding (such as the “T-shaped” plugs); in the accompanying figures several types of plugs in random coupling with the ducts 100 are shown to understand that they can have various uses.

1. A tube heat exchange assembly comprising
a tube plate (101) that has a first face which, in use conditions, is facing inside a heat exchange chamber (140), and a second face opposite to said first face and which, in use conditions, is facing outside said heat exchange chamber (140),
at least one through hole (103) which passes through the thickness of said tube plate (101)
at least one heat exchange tube (100) which passes through said through hole (103) and is operatively associated with a supply circuit of a heat exchange fluid
characterised in that
said tube heat exchange assembly further comprises at least one sleeve (200) opened at the opposite ends and fixed to said tube plate (101) and to said tube (100), said sleeve (200) being housed in said hole (103) and fitted on said tube (100) at of a section of the latter wherein it crosses the thickness of the tube plate (101), wherein furthermore said sleeve (200) protrudes beyond said first face of the tube plate (101), so that a first open end thereof ends inside said heat exchange chamber (140).

2. The heat exchange assembly according to claim 1, wherein said sleeve (200) is fixed alternately or in combination to the tube plate (101) or to the tube (100) by welding.

3. The heat exchange assembly according to claim 1, wherein there is no welding between said tube (100) and said tube plate (101), said sleeve (200) being completely interposed between the two.

4. The heat exchange assembly according to claim 1, wherein said sleeve (200) protrudes beyond said second face of the tube plate (101), so that its second open end ends outside said heat exchange chamber (140).

5. The heat exchange assembly according to claim 2, wherein said sleeve (200) is welded to said tube plate (101) by a first weld (105) made between a body portion of said sleeve (200) and the edge of said hole (103), from the side of the first face of said tube plate (101), so that said first weld (105) is housed in said heat exchange chamber (140).

6. The heat exchange assembly according to claim 2, wherein said sleeve (200) is welded to said tube (100) by a second weld (106) made between the first open end of the sleeve (200) and a contiguous portion of the outer lateral surface of said tube (100), so that said second weld (106) is housed inside said heat exchange chamber (140).

7. The heat exchange assembly according to claim 2, wherein said sleeve (200) is welded to said tube (100) by a second weld (107) made between the first open end of the sleeve (200) and a contiguous portion of the outer lateral surface of said tube (100), so that said second weld (107) is housed outside said heat exchange chamber (140).

8. The heat exchange assembly according to claim 1, comprising a plurality of tubes (100) and corresponding holes (103) and sleeves (200) wherein said sleeves (200) protrude from the first face (101a) of said plate (101) for lengths which are alternately equal or different one from another.

9. The heat exchange apparatus comprising a shell wall and a tube heat exchange assembly according to claim 1, wherein said tube plate (101) is arranged to delimit, in cooperation with said shell, said heat exchange chamber (140) and wherein said first face of said tube plate (101) is facing inside said heat exchange chamber (140).

10. An apparatus according to claim 9, comprising at least one inlet mouth for urea in the molten state, under pressure and at a temperature of 135-145° C., inside said heat exchange chamber (140), said heat exchange chamber (140) acting as a reaction chamber (14) for the pyrolysis of said urea with formation of melamine.

11. An apparatus according to claim 9, comprising a recirculation duct internal to said heat exchange chamber (140), further comprising a plurality of tubes (100) and respective sleeves (200) which extend in said chamber (140), wherein the sleeves (200) which are closest to the recirculation duct have a length greater than the others.

12. An apparatus according to claim 10, comprising a recirculation duct internal to said heat exchange chamber (140), further comprising a plurality of tubes (100) and respective sleeves (200) which extend in said chamber (140), wherein the sleeves (200) which are closest to the recirculation duct have a length greater than the others.

13. The heat exchange assembly according to claim 3, wherein said sleeve (200) is welded to said tube plate (101) by a first weld (105) made between a body portion of said sleeve (200) and the edge of said hole (103), from the side of the first face of said tube plate (101), so that said first weld (105) is housed in said heat exchange chamber (140).

14. The heat exchange assembly according to claim 3, wherein said sleeve (200) is welded to said tube (100) by a second weld (106) made between the first open end of the sleeve (200) and a contiguous portion of the outer lateral surface of said tube (100), so that said second weld (106) is housed inside said heat exchange chamber (140).

15. The heat exchange assembly according to claim 5, wherein said sleeve (200) is welded to said tube (100) by a second weld (106) made between the first open end of the sleeve (200) and a contiguous portion of the outer lateral surface of said tube (100), so that said second weld (106) is housed inside said heat exchange chamber (140).

16. The heat exchange assembly according to claim 3, wherein said sleeve (200) is welded to said tube (100) by a second weld (107) made between the first open end of the sleeve (200) and a contiguous portion of the outer lateral surface of said tube (100), so that said second weld (107) is housed outside said heat exchange chamber (140).

17. The heat exchange assembly according to claim 5, wherein said sleeve (200) is welded to said tube (100) by a second weld (107) made between the first open end of the sleeve (200) and a contiguous portion of the outer lateral surface of said tube (100), so that said second weld (107) is housed outside said heat exchange chamber (140).
